(19) United States
(12) Patent Application Publication
(10) Pub. No.: US 2006/0204652 A1
(43) Pub. Date: Sep. 14, 2006

(54) Method for contacting circuit board conductors of a printed circuit board

(75) Inventor: Dieter Meier, Bad Nenndorf (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LPKF Laser & Electronics AG, Garbsen (DE)

(21) Appl. No.: 11/371,823

(22) Filed: Mar. 9, 2006

(30) Foreign Application Priority Data
Mar. 10, 2005 (DE) DE102005011545.4

(51) Int. Cl. B05D 5/12

(52) U.S. Cl. 427/97.7

(57) ABSTRACT

A method for electrically connecting first and second circuit board conductors of a printed circuit board, wherein the first and second circuit board conductors being disposed in different planes of the circuit board and separated by an insulator layer, includes the step of placing a cover onto at least one of the first and second circuit board conductors and making a cutout through the cover, the insulator layer and the first and second circuit board conductors. In addition, an electrically conductive layer is applied under mechanical load onto the cover at least in the area of the cutout so that an electric connection is created along an inner wall surface of the cutout between the first and second circuit board conductors via the electrically conductive layer.

Priority is claimed to German Patent Application No. DE 10 2005 011 545.4, filed on Mar. 10, 2005, the entire disclosure of which is incorporated by reference herein.

The present invention relates to a method for contacting circuit board conductors of a printed circuit board—said circuit board conductors being arranged in different planes and connected by an insulator layer—by means of a conductive layer that electrically connects the two circuit board conductors.

### BACKGROUND

With such a method, according to the state of the art, a special conductive paste that acts as a conductive layer can be used to produce through-plated contacts that can be soldered and assembled on two-sided printed circuit boards whose outer circuit board conductors are electrically insulated with respect to each other by means of an insulator layer. Here, the diameter of the openings configured as drilled holes that connect the two printed circuit boards is between 0.5 mm and 1.4 mm.

For this purpose, a metering needle is used to automatically inject a special conductive paste into the drilled holes and to suction it off in a following work step. The subsequent curing in a hot-air oven results in through-plated contacts that are durable and especially that can be assembled. The entire process of creating through-plated contacts is controlled automatically by means of special software. The parameters for a specific drilled hole diameter are stored in the tools library of the software. In combination with the individual definition of the dispensing parameters, this method is already employed to apply soldering paste, adhesive and sealants.

It has been found to be disadvantageous that considerable effort is necessary in order to control the metering needle used for the conductive paste. In particular, all of the positions have to be approached individually and the appropriate quantity has to be dispensed as a function of the characteristics of the drilled hole. This renders the execution of the method extremely time-consuming.

Methods to mechanically connect the opposing circuit board conductors of a printed circuit board are likewise known from the state of the art. For example, through-plated contacting rivets made of a copper alloy and having a diameter between 0.3 mm and 1.4 mm are employed for this purpose. The through-plated contacting rivets are manually inserted into the hole previously drilled in the printed circuit board and then riveted using a pressing tool. This manual technique stands out for entailing little effort and minimal costs.

A drawback here is the fact that this method does not allow automation to any great extent, so that in actual practice, this method is reserved for special application cases.

### SUMMARY OF THE INVENTION

An object of the present invention is to provide a simplified contacting method that avoids one or more of the disadvantages discussed above. In particular, an object is to reduce the effort needed to control the execution of the method.

The present invention provides a contacting method which a cover is placed, at least in sections, onto the circuit board conductors in at least one plane, whereby subsequently, a cutout is made through the cover in the insulator layer and in at least one circuit board conductor, and the electrically conductive layer is applied under mechanical load onto the cover, at least in the area of the cutout, so that an electric connection is created along the inner wall surface of the cutout or recess between the circuit board conductors. The covers are subsequently removed. In this manner, it has become possible for the first time to achieve through-plated contacting on a printed circuit board whose circuit board conductors are already present in that the substance that forms the conductive layer is applied over the entire surface, thereby considerably reducing the effort needed for control purposes. To this end, first of all, a cover that protects the printed circuit board is applied temporarily, through which the cutout in the form of a hole is drilled into the printed circuit board in such a way that the two circuit board conductors can be connected through the drilled hole. The layer is then applied over the entire surface, it penetrates into the cutout and reliably adheres to the inner wall surface of the cutout so that a through-plated contact of the circuit board conductors lying in parallel planes is realized in this area. In order to ensure that the substance that forms the layer can reliably penetrate into the cutout, the substance is additionally subjected to mechanical load, in particular, it is pressed into the cutout at an elevated pressure, so that a continuous wetting between the circuit board conductors is ensured over the entire surface.

In this context, an especially advantageous embodiment of the method according to the invention is achieved in that the metallization layer employed has thixotropic properties or else a Bingham medium is formed. As a result, the mechanical load, for instance, brought about by a punch or by the effect of ultrasound, causes the solid or moldable state to change into the liquid state. Since a load is no longer being applied onto the substance inserted into the cutout after the procedure has been completed, the substance once again solidifies in the cutout, thereby avoiding undesired dripping or shifting and thus an interruption of the desired through-plated contact.

For this purpose, according to a particularly advantageous refinement of the method, negative pressure is generated in the cutout on the side facing away from the layer. As a result, it is not only possible to reliably suction off excess amounts of the substance, thus preventing undesired material accumulations, but at the same time, to greatly improve the reliability of the wetting of the inner wall surface, thus shortening the duration of the process.

The layer can be applied in virtually any desired manner. For example, the liquid substance could be sprayed out of a pressurized container onto the cover. However, it is particularly simple for the layer to be applied with a doctor blade. With this technique, the substance can be applied in a simple manner, for instance, also locally dissolved, and it only liquefies once a mechanical load is exerted by the doctor blade. Consequently, the requisite quantity of the substance can be dispensed without any problem at the desired position on the cover, so that any amounts that are not needed can be removed or else saved for future use.

The cutout, in the form of a pocket hole, can extend through the first circuit board conductor and the printed circuit board, reaching the surface of the second circuit board conductor. By the same token, in the case of printed circuit boards having more than two circuit board conductors arranged in different planes- and each being connected by an insulator layer, the cutout for contacting at least two circuit board conductors can likewise be configured as a pocket hole. In contrast to this, according to another particularly practical variant, the cutout can be configured as an opening through the printed circuit board so that the substance can be inserted into the opening from both sides, thus achieving an optimized contacting. To this end, a cover is applied onto both circuit board conductors.

In this context, it has proven to be especially practical for the printed circuit board to be moved out of a first horizontal position in which the first cover faces upwards, into a second inversed position in which the second cover faces upwards, and for another layer to be applied onto this second cover. This results in a reliable wetting of the inner wall surface of the opening even if the printed circuit board consists of thick material. Here, the substance adheres to the inner wall surface in such a way that a middle area is left free, with the consequence that a negative pressure during the application of the second layer also acts upon the substance through the opening.

The cover can be applied in virtually any desired form that later allows the cover to be removed without leaving residues. However, a variant that is particularly suitable in actual practice is one in which the cover comprises a film or coating. This can be a commercially available film, especially a self-adhesive film, that can be applied onto the circuit board conductor either manually or in an automated procedure. Consequently, at the same time, a uniform material thickness is ensured. Moreover, the film or coating allows a simple visual inspection of the entire cover. The film can also be transparent or translucent so as to simplify the positioning of the tool relative to the cutout.

Furthermore, it is especially advantageous if the dimensions of the cutout are adapted to the properties of the layer so as to ensure a constant layer thickness on the inner wall surface of the cutout. Here, it is particularly the case that the relationship between the cutout surface and the thickness of the material of the printed circuit board is adapted especially to the thixotropic properties of the substance.

The thixotropic properties of the metallization paste permit a neat and residue-free removal of the film. In this context, the process of peeling off the film, which should preferably be done at an angle of 45°, causes the metallization paste to be drawn towards the printed circuit board material in a manner that is free of residues and without the formation of impurities (formation of projections) after the separation procedure, while the adjustment of the film thickness ensures the requisite paste reservoir for a reliable contacting.

It has also been found to be appropriate in actual practice for the layer to contain silver as one of its components.

Naturally, the invention is not restricted to just two circuit board conductor planes, but rather, it can also be advantageously employed for printed circuit boards with any desired number of planes. Moreover, the substance in liquid form can be dispensed in liquid form with a metering needle, whereby here it is optionally also possible to do without the covers.

### BRIEF DESCRIPTION OF THE DRAWINGS

The invention allows various embodiments. For purposes of better elucidating its basic principle, one of these embodiments is presented in the drawing and will be described below. The drawing shows schematic diagrams depicting the process steps, whereby the following is shown:

FIG. 1 a printed circuit board with two circuit board conductors;

FIG. 2 the printed circuit board with two covers, each protecting a circuit board conductor;

FIG. 3 the application of the substance that forms the layer onto the first cover,

FIG. 4 the application of the substance onto the second cover; and

FIG. 5 the printed circuit board after the covers have been removed.

### DETAILED DESCRIPTION

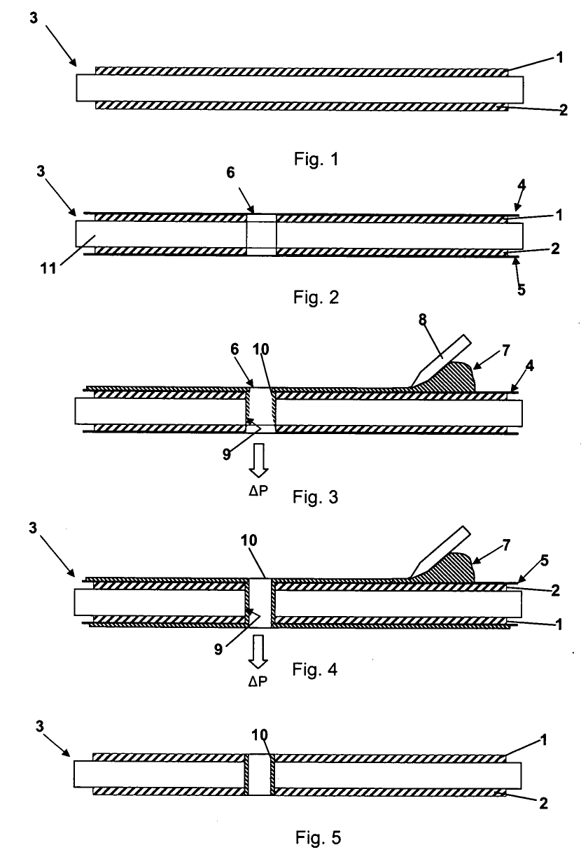

FIGS. 1 to 5 show the individual process steps of the method according to the invention for contacting two circuit board conductors 1, 2 arranged in two parallel planes of a printed circuit board 3. On the basis of the printed circuit board 3 with its outer circuit board conductors 1, 2 as shown in FIG. 1, in a first step as shown in FIG. 2, both circuit board conductors 1, 2 are each protected with a cover 4,5 configured as a film. Subsequently, using a tool not shown here, a cutout 6 configured as an opening is made in the printed circuit board 3, including the two circuit board conductors 1, 2, and in their covers 4, 5 through the circuit board conductors 1, 2 as well as through an insulator layer 11 that connects said circuit board conductors 1, 2 so as to insulate them. Once the printed circuit board 3 has been prepared in this manner, as shown in FIG. 3, a substance 7 is applied onto the cover 4 by means of a doctor blade 8 and said cover 4 changes to the liquid state under the mechanical load to which it is subjected. In addition, a negative pressure AP is exerted on the opposite side of the cutout 6, said negative pressure AP promoting the penetration of the substance 7 into the cutout 6. As a result, the substance 7 forms an electrically conductive layer 10 on the inner wall surface 9 of the cutout 6, said layer 10 solidifying due to the diminished mechanical load inside the cutout 6. As can be seen in FIG. 4, the process with the doctor blade is repeated once the printed circuit board 3 has first been turned over, so that now the substance 7 is applied onto the other cover 5. As a result, the inner wall surface 9 is wetted over the entire surface with the substance 7 that forms the layer 10 and the contacting of the two circuit board conductors 1, 2 is thus reliably ensured. As shown in FIG. 5, after the two covers 4, 5 have been removed, the reliable through-plated contacting of the two opposing circuit board conductors 1, 2 of the printed circuit board 3 is now achieved, whereby the electrically conductive layer 10 can optionally still be cured in a subsequent process step under exposure to thermal energy.

What is claimed is:

1. A method for electrically connecting first and second circuit board conductors of a printed circuit board, the first and second circuit board conductors being disposed in different planes of the circuit board and separated by an insulator layer, the method comprising:
placing a cover onto at least one of the first and second circuit board conductors;
making a cutout through the cover, the insulator layer and the first and second circuit board conductors;
applying an electrically conductive layer under mechanical load onto the cover at least in the area of the cutout so that an electric connection is created along an inner wall surface of the cutout between the first and second circuit board conductors via the electrically conductive layer.

2. The method as recited in claim 1, wherein the placing of the cover is performed in sections.

3. The method as recited in claim 1, wherein the electrically conductive layer includes a substance having thixotropic properties.

4. The method as recited in claim 1, wherein the applying of the electrically conductive layer includes generating a negative pressure in the cutout on a side facing away from the layer.

5. The method as recited in claim 1, wherein applying of the electrically conductive layer is performed using a doctor blade.

6. The method as recited in claim 1, wherein the cutout is configured as an opening through the printed circuit board.

7. The method as recited in claim 1, wherein a cover is placed onto both of the first and second circuit board conductors.

8. The method as recited in claim 1, further comprising moving the printed circuit board from a first horizontal position, in which the cover on the first circuit board conductor faces upwards, into a second inversed horizontal position, in which the cover on the second circuit board conductor faces upwards, and applying a further electrically conducting layer onto the cover of the second circuit board conductor.

9. The method as recited in claim 1, wherein the cover includes at least one of a film and a coating.

10. The method as recited in claim 1, wherein the making of the cutout includes adapting dimensions of the cutout to at least one property of the electrically conductive layer.

11. The method as recited in claim 1, wherein the electrically conductive layer includes silver.
